(19) United States
(12) Patent Application Publication
(10) Pub. No.: US 2016/0206151 A1
(43) Pub. Date: Jul. 21, 2016

(54) Apparatus for Attaching a Disposable Cup to a Blender

(71) Applicants: Bailey L. Heit, Los Altos Hills, CA (US); Ryder C. Heit, Los Altos Hills, CA (US); Warren S. Heit, Los Altos Hills, CA (US)

(72) Inventors: Bailey L. Heit, Los Altos Hills, CA (US); Ryder C. Heit, Los Altos Hills, CA (US); Warren S. Heit, Los Altos Hills, CA (US)

(21) Appl. No.: 14/598,991

(22) Filed: Jan. 16, 2015

(51) Int. Cl. A47J 43/07; A47J 43/044

(52) U.S. Cl. CPC A47J 43/0705; A47J 43/044; A47J 2043/04454

(57) ABSTRACT

An apparatus is provided for attaching a disposable cup to a blender. The apparatus comprises a mating collar for attaching the apparatus to a blender, a support base designed to support the disposable cup in an inverted orientation when the drink is being blended and a clamp ring designed to clamp the disposable cup to the support base.

### FIELD OF THE INVENTION

The present invention relates to an apparatus for attaching a disposable cup to a blender.

### BACKGROUND OF THE INVENTION

Commercial establishments such as Starbucks®, Jamba Juice®, McDonalds®, bars, and ice cream shops that serve blended beverages have become increasingly popular largely due to the health craze surrounding smoothies and other blended drinks. People have turned to blended drinks of all sorts of concoctions of different ingredients in an effort to live healthier lifestyles. Blenders come in all different shapes and sizes. However, the time and trouble associated with dispensing blending drinks into disposable cups and cleaning the reusable plastic vessels in which the drinks are blended reduce the profitability of establishments that serve blended drinks.

### SUMMARY OF THE INVENTION

In accordance with one embodiment of the invention, an apparatus is provided for attaching a disposable cup to the blender. The apparatus comprises a mating collar for attaching the apparatus to blender. The mating collar takes different forms and sizes because the blade assemblies of different brands of blenders come in different shapes are sizes. The mating collar is designed to mate the apparatus of the present invention with the specific blade assembly associated with a particular brand of blender.

The apparatus of the present invention further comprises a support base. The support base is designed to support a disposable cup in an inverted orientation when the drink is being blended. The rolled rim of the disposable cup contacts and is supported by a horizontal flat surface of the support base. The support base includes a cylindrical cavity and a cup collar—typically a cylindrical or conical collar—circumscribing the cylindrical cavity. The support base further includes a clamp collar around the perimeter of the support base. The clamp collar has threads on its inwardly facing cylindrical surface.

The apparatus further comprises a clamp ring. The clamp ring is cylindrical and is designed to fit over the inverted disposable cup. The ring clamp has threads on its outwardly facing cylindrical face. The threads are designed to mate with the threads on the clamp collar associated with the support base. The clamp ring is screwed down onto the support base. As the clamp ring is screwed down, the lower horizontal surface of the clamp ring is lowered down onto the rolled rim of the disposable cup. Continued tightening of the clamp ring forces the rolled rim of the inverted disposable cup into pressing contact with the horizontal flat surface of the support base.

In an alternative embodiment, the apparatus further comprises a seal ring. The seal ring is manufactured from silicon, rubber, plastic or other appropriate sealing material. The seal ring is design to fit on at least the horizontal flat surface of the support base. As the clamp ring is screwed down, the lower horizontal surface of the clamp ring presses the rolled rim of the disposable cup onto the seal ring to form a substantial seal. The seal ring may extend to cover some or the entire outer surface of the cup collar to further improve the quality of the seal.

For purposes of summarizing the advantages achieved over the prior art, certain advantages have been described herein above. Of course, it is to be understood that not necessarily all such advantages may be achieved in accordance with any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is an illustration of a cross-section of the apparatus in accordance with an embodiment of the invention;

FIG. 2 is an illustration of a cross-section of the apparatus in accordance with an embodiment of the invention showing additional elements;

FIG. 3 is an illustration of a cross-section of the apparatus in accordance with an alternative embodiment of the invention showing additional elements;

FIG. 4 is an illustration of a cross-section and overhead view of the apparatus in accordance with an embodiment of the invention;

FIG. 5 is an illustration of a cross-section and overhead view of the apparatus in accordance with an alternative embodiment of the invention;

FIG. 6 is an illustration of a cross-section and overhead view of the apparatus in accordance with an embodiment of the invention;

FIG. 7 is an illustration of a cross-section and overhead view of the apparatus in accordance with an alternative embodiment of the invention;

FIG. 8 is an illustration of a cross-section view of the apparatus in accordance with an embodiment and alternative embodiment of the invention;

FIG. 9 is an illustration of the apparatus in accordance with an alternative embodiment of the invention;

FIG. 10 is an illustration of the apparatus in accordance with an alternative embodiment of the invention;

FIG. 11 is an illustration of the apparatus in accordance with an alternative embodiment of the invention; and

FIG. 12 is an illustration of a web interface in accordance with an embodiment of the invention.

### DETAILED DESCRIPTION OF THE EMBODIMENTS OF THE INVENTION

The present invention will now be described with reference to the figures which in embodiments relate to an apparatus for attaching a disposable cup to a blender. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

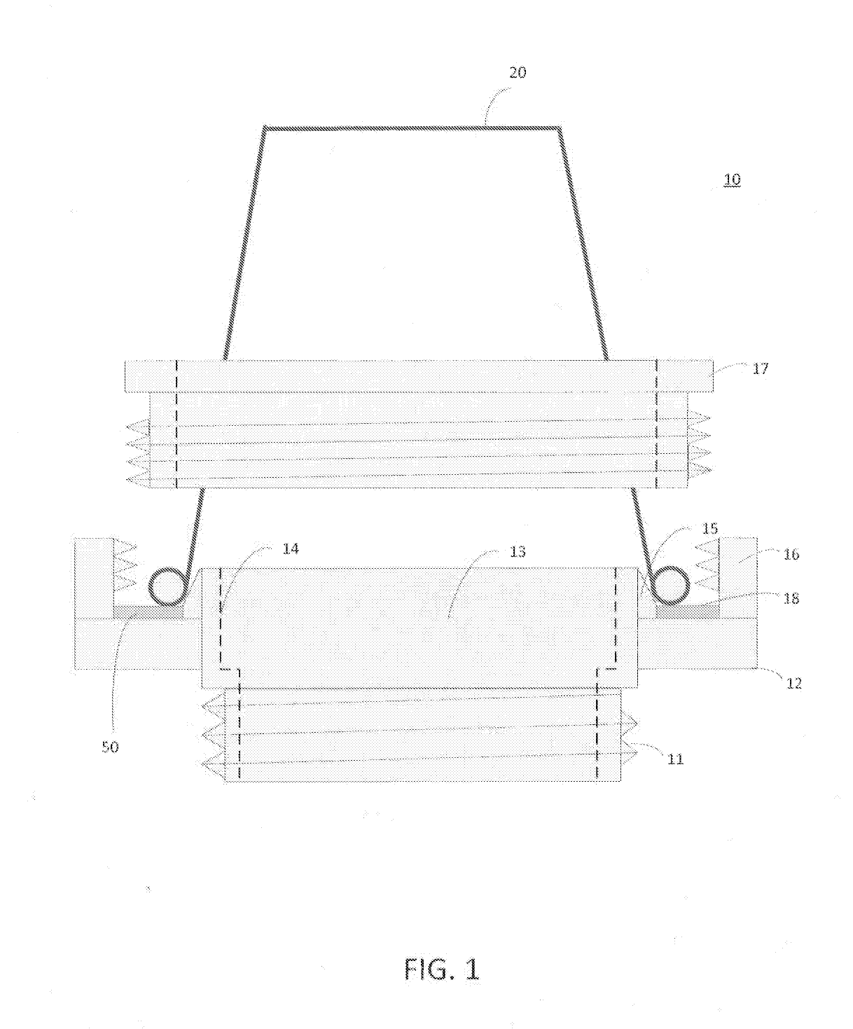

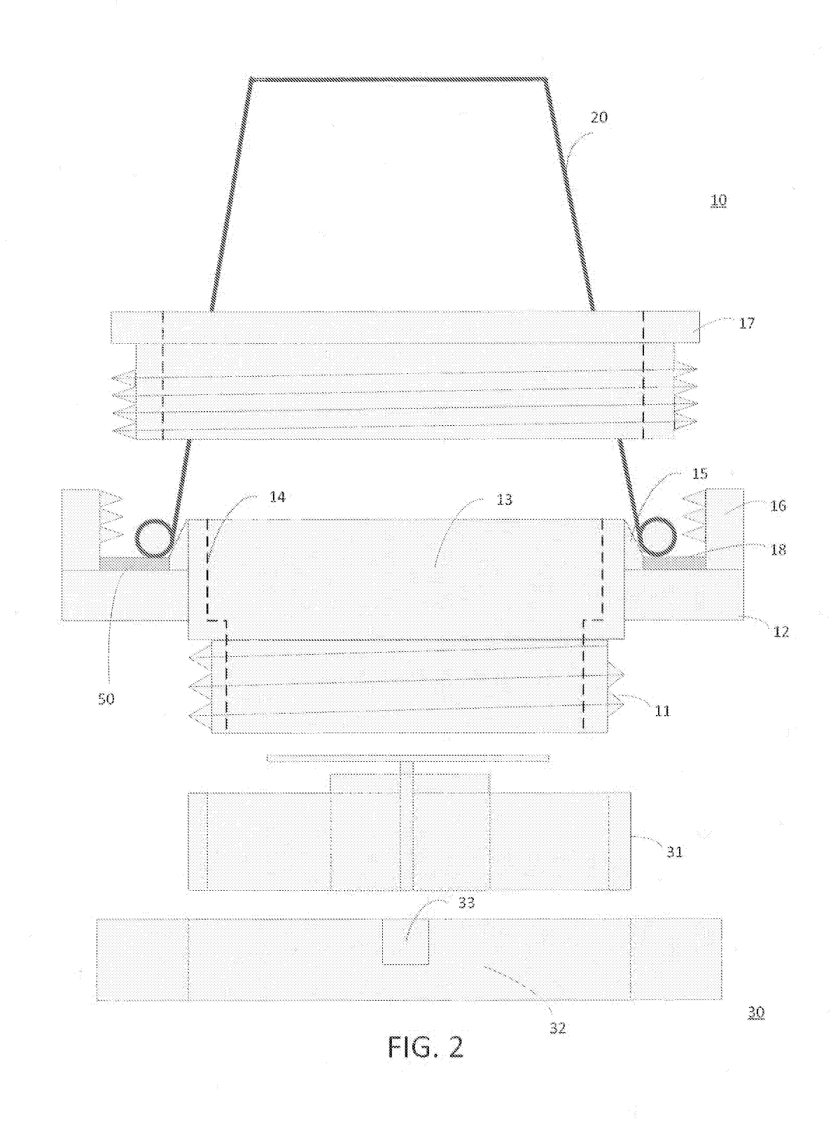

In accordance with an embodiment of the invention illustrated in FIGS. 1 and 2, an apparatus 10 is provided for attaching a disposable cup 20 to a blender 30. The apparatus 10 includes mating collar 11. Mating collar 11 is cylindrical in nature. Mating collar 11 is designed to mate with a blade assembly 31 associated with a particular brand of blender 30. In the embodiment illustrated in FIGS. 1 and 2, the outside of mating collar 11 includes threads designed to allow the mating collar 11 to mate with the threads of the collar of the blade assembly 31. The tolerances of the threading create a substantially sealed interface between the matting collar 11 and the blade assembly 31. It is understood that the mating collar 11 may have a wide variety of configurations for mating with a wide variety of mating interfaces of different blade assemblies 31. As one further embodiment, the threads (or other mating interface) on the mating collar may face inward toward an axial center of the mating collar, instead of facing outward as shown in FIGS. 1 and 2.

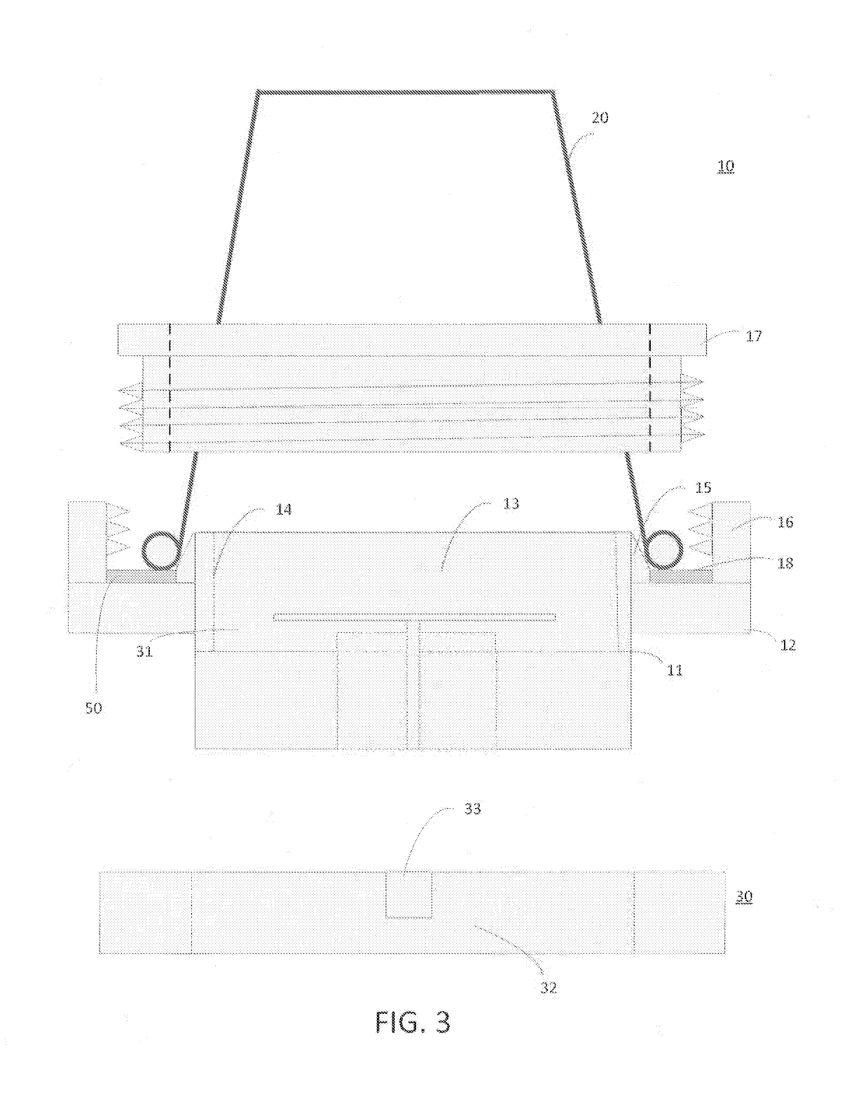

In accordance with an alternative embodiment of the invention illustrated in FIG. 3, blade assembly 31 is integrally formed with, or otherwise removably or permanently affixed to, the support base 12 (explained below). According to this embodiment, the blade assembly 31 mates with the motor housing 32 of blender 30 such that the drive socket 33 of the blender drives the blade assembly 31. An advantage of this alternative embodiment is that by incorporating blade assembly 31 directly to support base 12, the complexity of the apparatus is reduced and the need to seal the interface between the mating collar 11 and blade assembly 31 is necessarily eliminated. The embodiments of FIGS. 1-3 allow the present technology to be used with conventional blenders, including those that use a blade assembly 31 which affixes to the blender base and those where the blade assembly is in the pitcher or container which affixes to the blender base.

Mating collar 11 will take different forms and sizes because the blade assemblies 31 and motor housings 32 of different brands of blenders are designed differently and therefore have different shapes are sizes, For example, the Magic bullet comes with a High-Torque Power Base, two blades—a cross blade and a flat blade—and bullet cups. Ingredients are loaded into the bullet cup. The cross or flat blade is placed on top of the opening of bullet cup and the blade is twisted until the blade and cup have a tight seal. The cup/blade combination is placed on the power base and the pressed down to turn the base on. The Black & Decker FusionBlade series of blenders come with a base, drinking lid attachments, personal blender jars, and a personal jar blade assembly. The personal blending jar is placed on the countertop with the open end facing up. The ingredients are placed in the jar. The blade assembly is screwed on top of the personal jar, securing tightly. The personal jar is then turned upside down and placed on the blender base. The jar/blade assembly is turned to the right to lock them into place. The on/off button is pushed to begin blending. When finished, the on/off button is pushed again to stop blending. The personal jar is turned over and then placed on the countertop. The blade assembly is unscrewed and replaced with a spill-proof travel lid. Other blenders, including the Nutri Ninja and Hamilton Beach—are similarly configured.

In order to improve the manufacturability of the apparatus of the present invention, it is desirable according to one embodiment of the present invention to allow different mating collars 11 be attachable to and interchangeable with different support bases 12. As previously mentioned, there are a variety of different blade apparatuses 31 for the various different models and brands of blenders. Therefore, there are different mating collars 11 for each of these different blades apparatuses. Similarly, there are a variety of different cup shapes and sizes. As a result, there are different support bases 12 for each of the different disposable cups. According to one embodiment, it is possible to easily mix and match the variety of different mating collars 11 with each of the different support bases 12. This avoids having to make a separate mating collar 11/support base 12 combination for each of the different blade apparatus 31/cup combinations. By making the different mating collars 11 and support bases 12 attachable to each other and interchangeable, manufacturing costs are significantly reduced.

According to this embodiment, each of the different mating collars 11 is designed with a similarly shaped and sized flange at one end. The flange may be in the shape of a circle or a regular polygon like a triangle or square, The flange includes a uniform distribution of holes to receive screws, pegs or other attachment mechanism. Complementarily, each of the different support bases 12 includes a similarly shaped indentation specifically design to match with and receive the flange on the ends of the different mating collars 11. Like the flange, the indentation includes the same uniform distribution of holes to receive the screws, pegs or other attachments mechanism. The holes may be threaded so that screws can secure the flange to the indentation. Alternatively, a glue or epoxy may be applied between the flange and indentation to attach the collar 11. A silicon, rubber or plastic seal may be included between the flange and the indentation to ensure a tight seal. The same principles and structures discussed herein apply to the embodiment show in FIG 3. The different blade assemblies 31 are designed with uniform flanges designed to match and fit into the indentations in the different support plates 12.

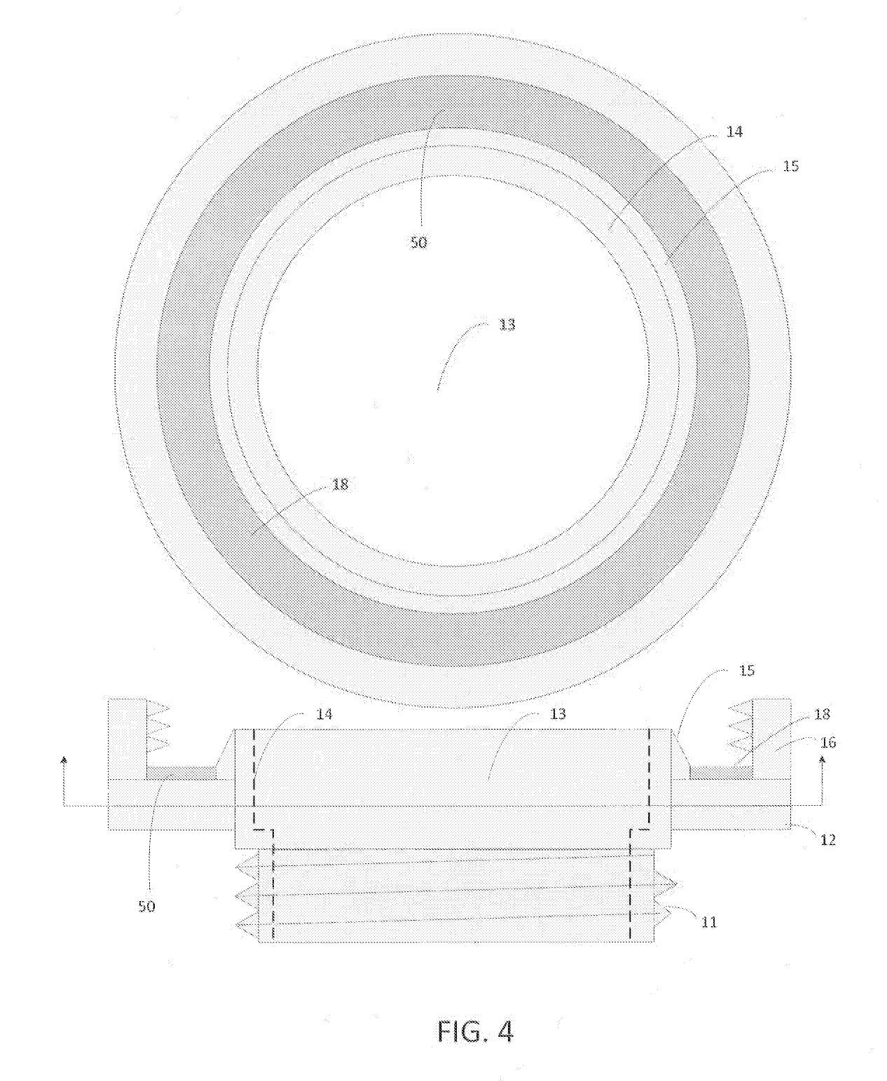

As illustrated in FIGS. 1-5, the apparatus further comprises a support base 12. Support base 12 may be cylindrical in nature. Support base 12 is designed to support the disposable cup in an inverted orientation when the drink is being blended. In operation, a disposable cup is inverted and the mouth of the cup is placed over a circular opening in the support plate 12. The rolled rim of the disposable cup contacts and is supported by a horizontal flat surface 18 of the support base 12. This is illustrated in FIGS. 1-5. Support base 12 is integrally formed with, or otherwise removably or permanently affixed to, the mating collar 11. When mating collar 11 is mated with blender 30 and blade assembly 31, support base 12 is maintained in a substantially horizontal position. In this way, the axis of the disposable cup is maintained in a vertical orientation, perpendicular to the horizontal flat surface 18 and the horizontal orientation of the blade plane.

Support base 12 includes a cylindrical cavity 13 formed by cavity walls 14 and cup collar 15. Because of the violence created by the blending operation, it desirable to protect the sides of the disposable cup from being directly impacted during blending. This is accomplished by the present invention in substantial part by the design of the cylindrical cavity 13. Cylindrical cavity 13 is designed to be sufficiently deep such that a substantial portion of the most violent blending operation occurs within the cavity 13. In this fashion, the plastic cavity walls 14 withstand the abuse from the blending operation, not the disposable cup. Cylindrical cavity 13 should be at least ¾ of an inch in depth and preferably at least 1 inch in depth. It may be greater or lesser than that in further embodiments.

The conical cup collar 15 circumscribing the circular opening may contact the interior walls of the cup around the cup's mouth opening. Cup collar 15 is typically cylindrical or conical. The angle of the outer surface of cup collar 15 relative to the horizontal flat surface 18 may be the same or similar to the angle of the sides of the cup at its mouth relative to the mouth of the cup. As a result, the outer surface of the cup collar 15 may be substantially parallel to the side of the disposable cup at its mouth.

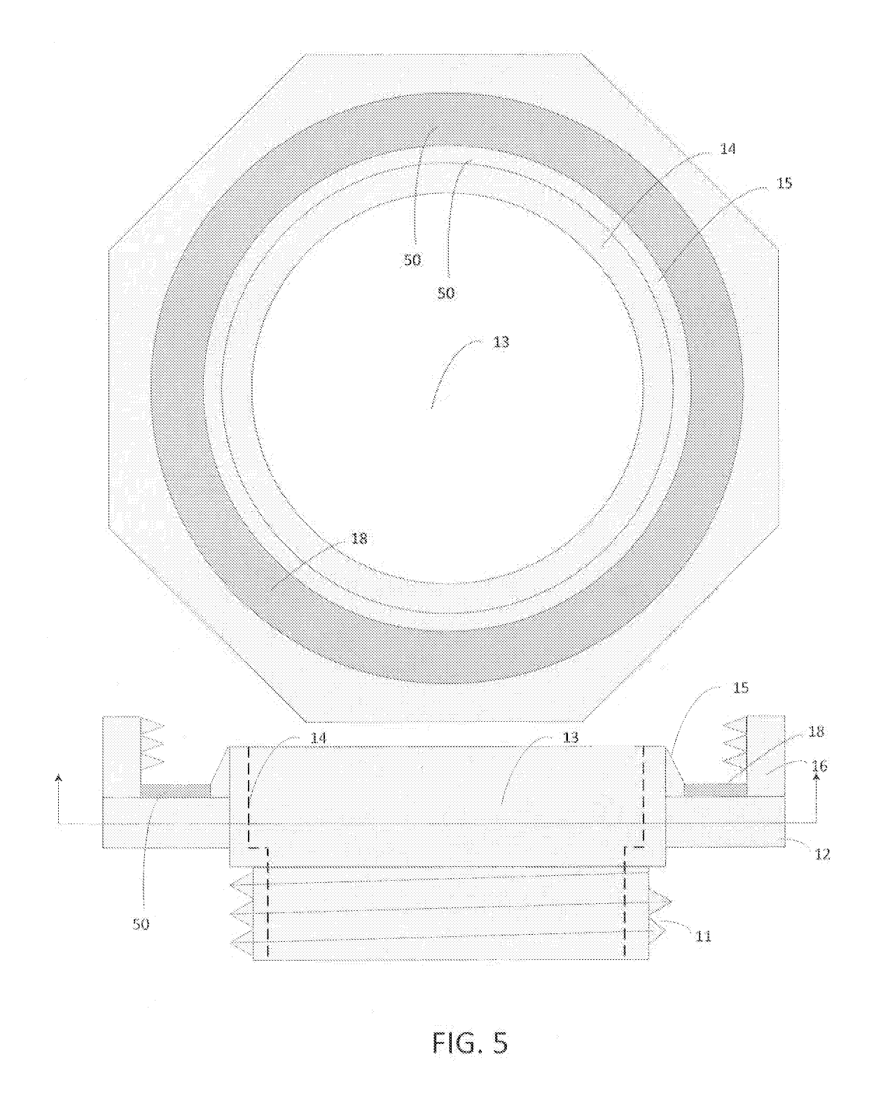

Support base 12 further includes a cylindrical clamp collar 16 around the perimeter of the support base 12. Clamp collar 16 has threads on its inwardly facing cylindrical surface. In alternative embodiments illustrated in FIG. 5, the outer surface of support base 12 and the clamp collar 16 are formed in the shape of a polygon with a number of sides. Forming the outer surface of support base 12 and clamp collar 16 in a polygonal shape assists the ability to grip and turn the support base. This advantageously facilitates the tightening and loosening of the support base 12 and mating collar 11 onto the blade assembly 31.

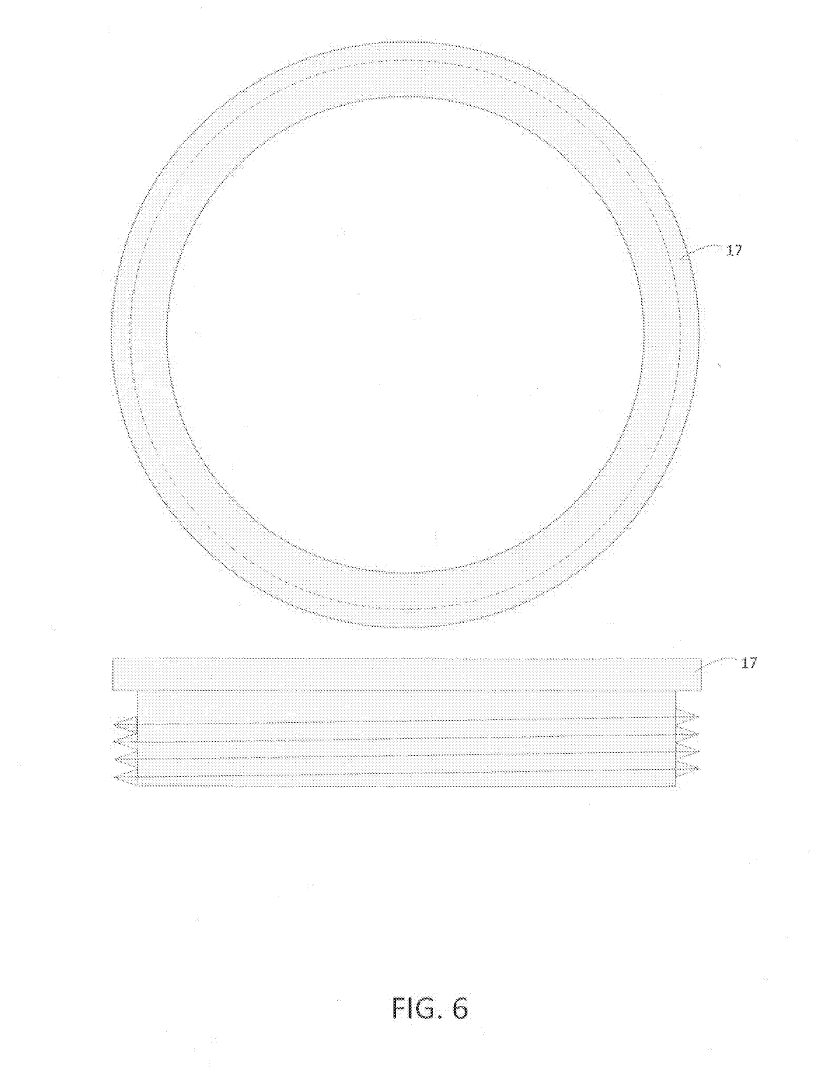

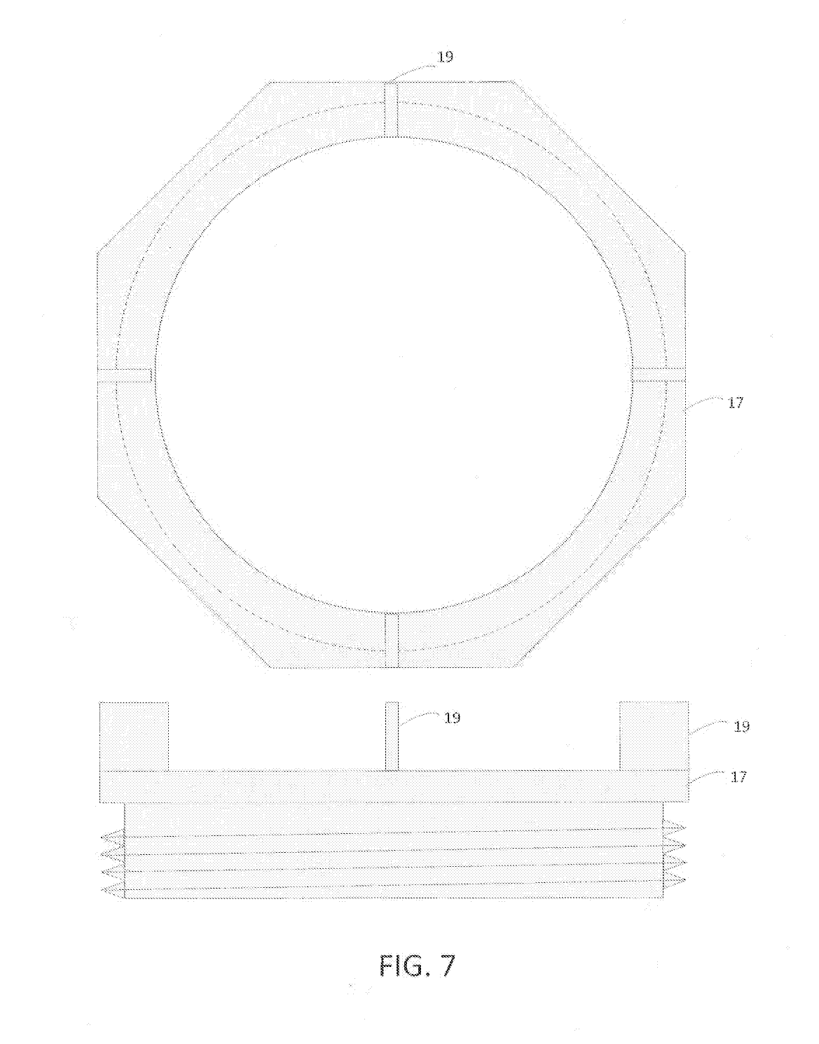

The apparatus further comprises a clamp ring 17. Clamp ring 17 is illustrated in FIGS. 1-3 and 6-10. Clamp ring 17 is designed to fit over the inverted disposable cup. Clamp ring 17 is cylindrical in nature. In alternative embodiments as illustrated in FIG. 7, at least the upper portion of the outer surface of clamp ring 17 is formed in the shape of a polygon with a number of sides. Forming the upper portion of the outer surface of clamp ring 17 in a polygonal shape assists the ability to grip and turn the clamp ring. This advantageously facilitates tightening and loosening of the clamp ring 17 onto the support base 12 and mating collar 11. As also illustrated in FIG. 7, one or more fins 19 may be formed on the clamp ring 17 to further facilitate the gripability and turnability of clamp ring 17.

Clamp ring 17 has threads on its outwardly facing cylindrical surface. The threads are design to mate with the threads of clamp collar 16 on the support base 12. Clamp ring 17 is designed to be screwed down onto the support base 12 by rotating clamp ring 17 about the central axis of the cylindrical apparatus. As clamp ring 17 is screwed down, the lower horizontal surface of the clamp is lowered down onto the rolled rim of the disposable cup. Continued tightening of the clamp ring 17 forces the rolled rim of the inverted disposable cup into pressing contact with the horizontal flat surface 18 of the support base 12. To facilitate cleaning of the threading of clamp ring 17 by simple rinsing under a faucet, it is beneficial to use threading on the clamp ring 17 With a relatively large pitch. In one embodiment, threading between 5 to 10 threads per inch is employed. Threading with a small pitch, or with a larger pitch, may be used in further embodiments.

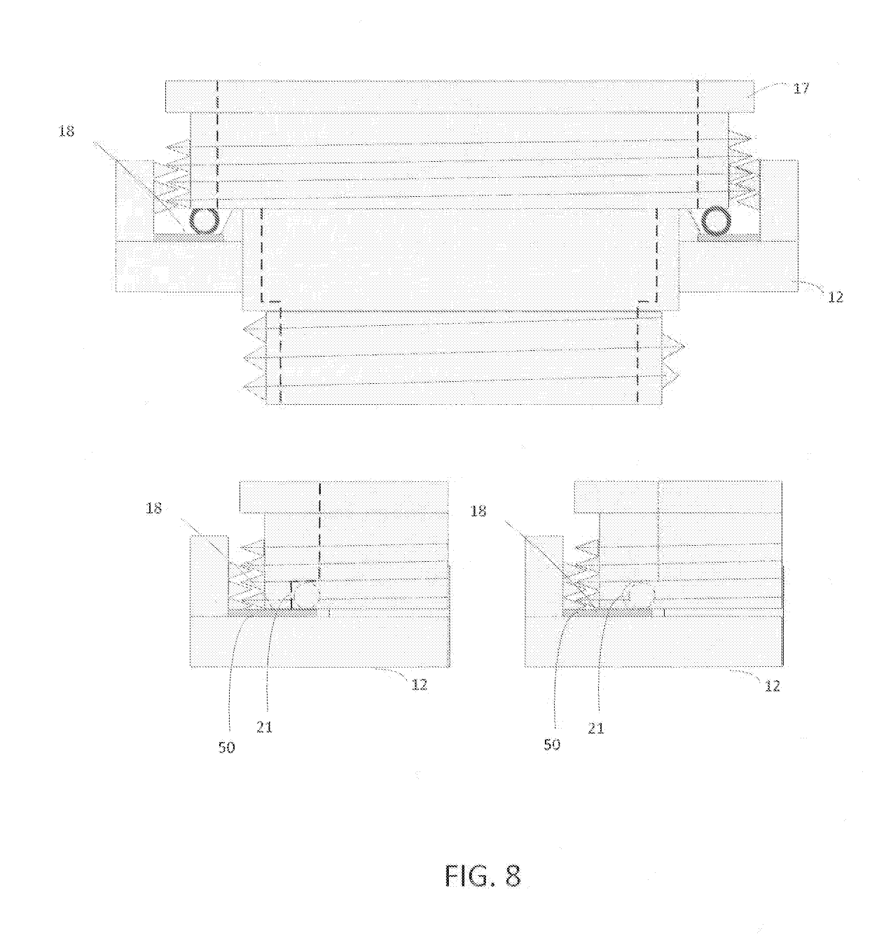

An alternative embodiment of clamp ring 17 is illustrated in FIG. 8. According to this embodiment, the lower surface of clamp ring 17 includes a hollow 21 into which the rim of the disposable cup fits. The cross section of hollow 21 is illustrated as rectangular or square in shape. The shape of hollow 21 may also advantageously be an arc of a circle, ellipse or other curved shape so it fits neatly around the rolled rim of the disposable cup 20. Hollow 21 advantageously improves the ability of the clamp ring 17 to hold the rolled rim in place. In addition, hollow 21 also allows the clamp ring to be screwed until the lower surface of the clamp ring is in contact with the horizontal flat surface 18 (including or not including the seal ring 50, explained below) while applying the appropriate amount of pressure on the rolled rim of the disposable cup to form an appropriate seal.

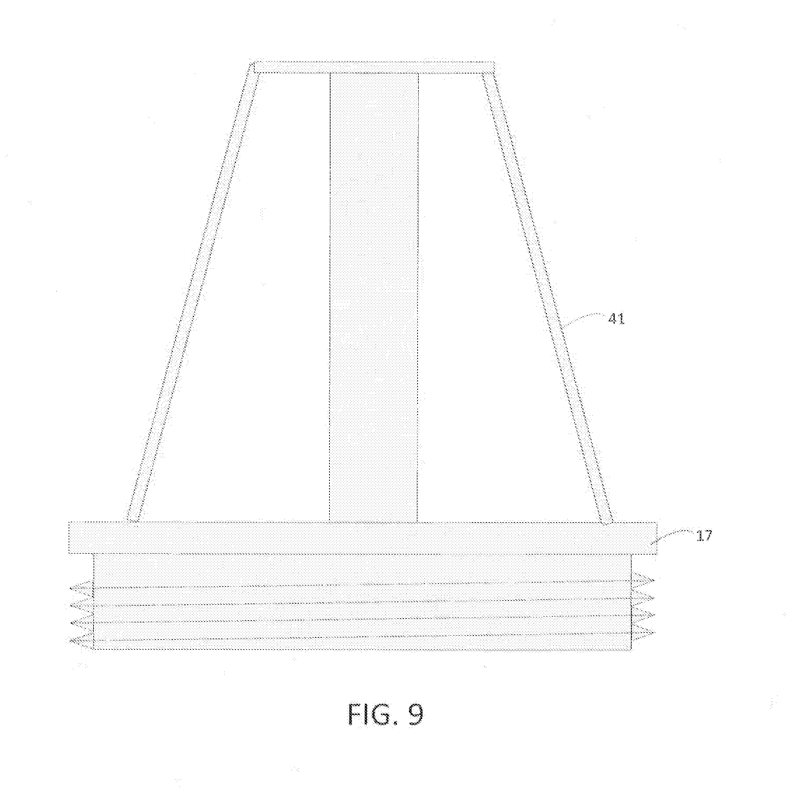

In embodiments in which a disposable cup that does not include a rolled rim is used, clamp ring 17 includes a pressing structure such as an enclosure to press the cup into a substantially sealed relationship with the horizontal flat surface 18 of the support base 12. For example, as illustrated in FIG. 9, clamp ring 17 includes one or more straps to create a cage 41 into which the disposable cup is seated. The cage 41 is formed so that when the disposable cup is seated in the cage 41 and the clamp ring 17 is screwed into place, the mouth of the cup is forced into a substantially sealed relationship with the horizontal flat surface 18 of the support base 12,

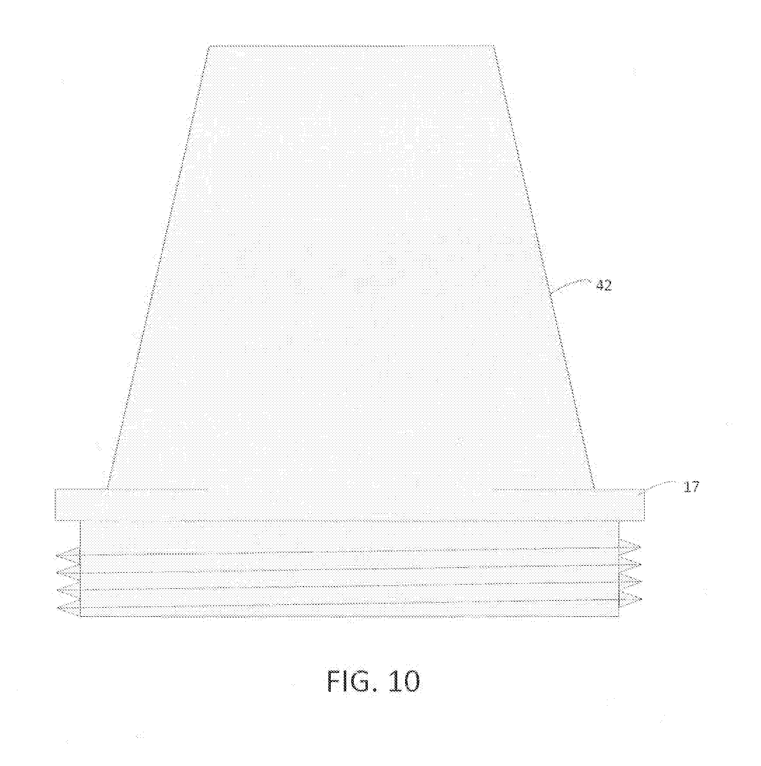

In an alternative embodiment, as illustrated in FIG. 10, clamp ring 17 includes a cup 42 that mates with the disposable cup. The cup 42 is formed so that when the disposable cup is seated in the cup 42 and the clamp ring 17 is screwed into place, the mouth of the disposable cup is forced into a substantially sealed relationship with the horizontal flat surface 18 of the support base 12.

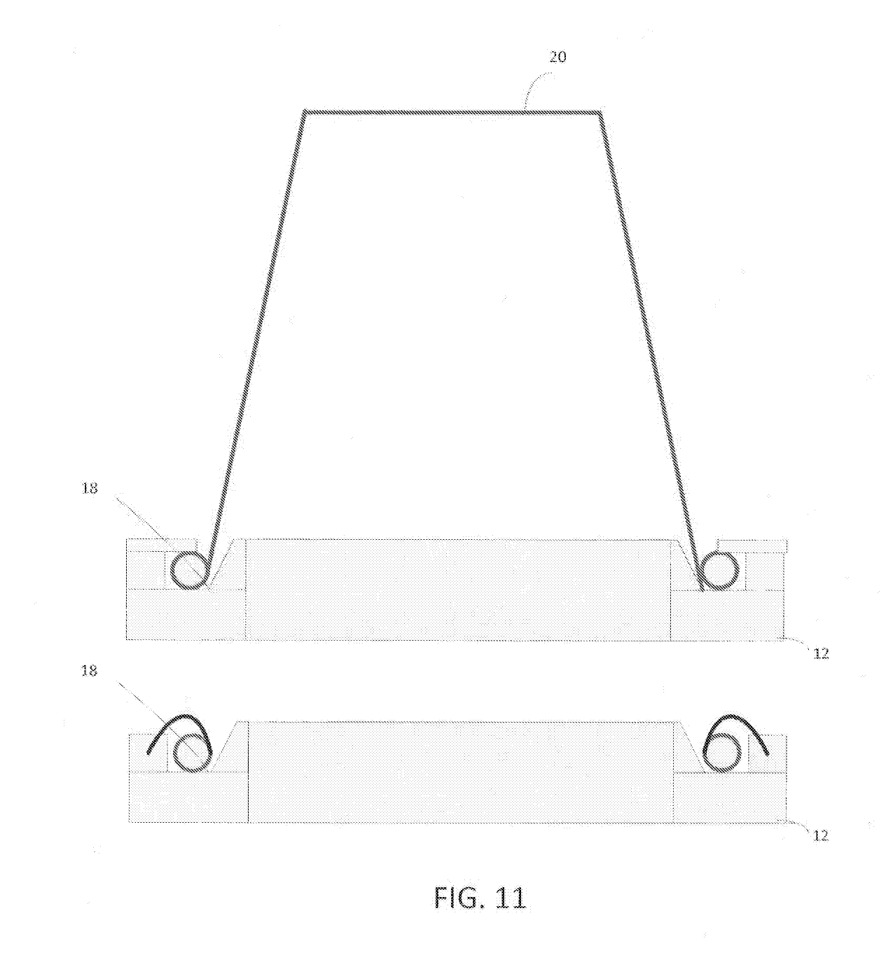

In a further alternative embodiment illustrated in FIG. 11, alternative clamping mechanisms may be used as alternative or in addition to the clamp ring. For example, spring loaded . clips may be deployed around the circumference of the support base. The spring loaded clips apply a downward force to the rolled rim.

In an alternative embodiment, the apparatus further comprises a seal ring 50. Seal ring 50 is illustrated in FIGS. 1-5. The seal ring 50 is preferably manufactured out of silicon, rubber, plastic or other appropriate sealing material. The seal ring 50 is design to fit on at least the horizontal flat surface of the support base 12. As clamp ring 17 is screwed down, the lower horizontal surface of the clamp ring 17 presses the rolled rim of the disposable cup onto the seal ring 50 to form a substantially sealed relationship. In embodiments illustrated in FIGS. 9 and 10, the cage 41 and cup 42 press the mouth of the disposable cup onto the sealing ring 50 to form a substantially sealed relationship. The sealing ring 50 may extend to cover some or the entire outer surface of the cup collar 16 to further enhances the seal.

In one of the many ways the present invention may be used, a user places a disposable cup 20 in the upright position on a table. It may be convenient to sit the cup inside the clamp ring 17 with the threaded side facing up. The user will load his/her ingredients into the cup. The user then places the support base 12 with the horizontal flat surface 18/seal 50 facing down onto the rim of the cup 20. Clamp ring 17 is elevated and screwed into the clamp collar 16 of support base 12 to seal the rim of the cup to the horizontal flat surface 18. For the embodiments illustrated in FIGS. 1 and 2, the mating collar 11 is facing upward. The blade assembly 31 is screwed and tightened onto the mating collar 11. For the embodiments illustrated in FIG. 3, the blade assembly is already attached to the support base 12. The entire apparatus 10 and disposable cup 20 is then inverted and couple to a suitable blender for blending.

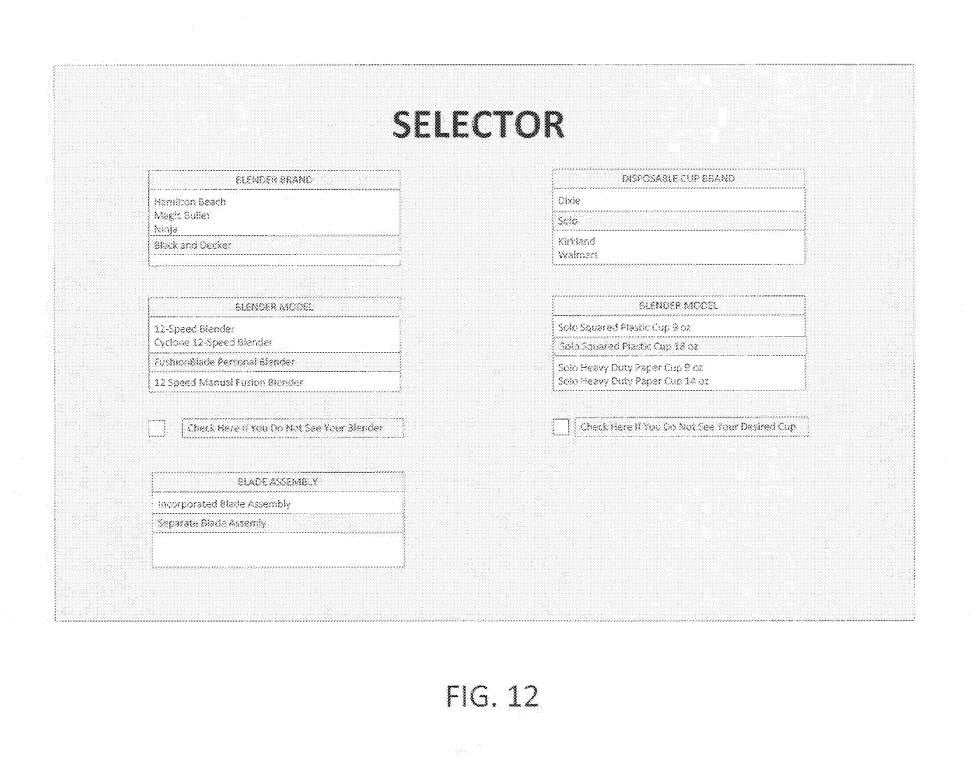

As illustrated in FIG. 12, a system and method is employed to help a customer identify the correct configuration of the apparatus. The system employs the Internet, a web interface and a remote server to interrogate the customer to collect the information the system needs to identify the correct configuration of the apparatus for the customer. Using the web interface, the customer is provided a first menu of different blender brands. The customer selects from the menu of different brands of blenders the particular brand of blender that the customer owns or desires to use. The customer is provided a second menu of different models of blenders corresponding to the particular brand of blender that the customer has selected. The customer selects from the menu of different models of blenders the particular model of blender that customer owns or desires to use. The customer is then provided a choice to use an incorporated blade assembly or a separate blade assembly. An explanation is provided to explain the difference between an incorporated blade assembly and a separate blade assembly. If the customer selects the “desired blender not identified”, the customer is provide with the ability to describe the blender the customer wants to use with the apparatus. With the customer's selections about the blender make, model and blade assembly, the system has sufficient information to determine the configuration of the mating collar 11 for the customer.

The customer is next provided a menu of different disposable cup brands. The customer selects from the menu of different disposable cup brands the particular brand of disposable cup that the customer owns or desires to use. The customer is provided a second menu of different models of cups (e.g., model and size) corresponding to the particular brand of disposable cup the customer has selected. The customer selects from the menu of different disposable cups the particular cup the customer owns or desires to use. The menu of different disposable cups includes a selection corresponding to “desired disposable cup not identified.” If the customer selects the “desired disposable cup not identified”, the customer is provide with the ability to describe the cup the customer wants to use with the apparatus. With the customer's selections about the disposable cup, the system has sufficient information to determine the configuration of the clamp ring 17.

The present invention provides a substantial benefit to any commercial establishment that sells blended beverages. This includes without limitation Starbucks, Jamba Juice, McDonalds, bars, and ice cream shops. The employees who are responsible for making blended drinks spend a substantial amount of time first pouring the contents of the vessel into a disposable cup (often having to bang on the vessel to empty its contents) and then cleaning the vessel in which blended drinks are typically made. The time spent pouring the contents of the vessel into a disposable cup and then cleaning the parts of the blender is waste. This time could be reduced substantially as a result of using the present invention. By replacing the plastic reusable vessels with the apparatus of the present invention, the employees would no longer have to pour the contents of the vessel into a disposable cup. That is already achieved by the present invention. In addition, the employees would no longer have to engage in the difficult and time-consuming task of cleaning the plastic vessels. This would be replaced by simply rinsing the apparatus of the present invention, which would take far less time. As a result, the employees are able to spend more time serving customers and turning around orders. This has a substantial benefit to the profitability of such commercial establishments.

A further benefit of the present invention is avoiding the waste of food and liquids that typically occurs when using a typical blender. Because the contents of the vessels have to be poured out, the employees typically have to compensate for the amount of blended product that gets “stuck” the walls of the vessel. This waste is advantageously avoided by the present invention,

Although this invention has been disclosed in the context of certain preferred embodiments and examples, it will be understood by those skilled in the art that the present invention extends beyond the specifically-disclosed embodiments to other alternative embodiments and/or uses of the invention and obvious modifications and equivalents thereof. In addition, while a number of variations have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed apparatus. Thus, it is intended that the scope of the present invention should not be limited by the particular disclosed embodiments described above, but should be determined only by a fair reading of the claims that follow.

What is claimed is:

1. An apparatus for attaching a disposable cup having a rim to a blade assembly separate from but attachable to a blender comprising:
a support base having a first face and a second face and an opening, the first face of the support base having a flat surface designed to support the rim of the disposable cup around the opening;
a clamp ring designed to press the rim of the disposable cup into pressing contact with the flat surface of the support base; and
a mating collar connected to the second face of the support base, the mating collar designed to mate with a blade assembly separate from but attachable to a blender.

2. An apparatus as in claim 1, the support base further comprising a clamp collar circumscribing the flat surface.

3. An apparatus as in claim 2, the clamp ring designed to work in cooperation with the clamp collar to press the rim disposable cup into pressing contact with the flat surface of the support base.

4. An apparatus as in claim 1, wherein the lower surface of the clamp ring includes a hollow.

5. An apparatus as in claim 1, wherein the flat surface of the support base includes a seal ring.

6. An apparatus as in claim 1, wherein the opening of the support base comprises a cavity having a thickness of at least ¾ of an inch in which the blade of the blade assembly is design to rotate.

7. An apparatus as in claim 1, wherein the clamp ring includes an enclosure to enclose at least a portion of the bottom of the cup.

8 An apparatus for attaching a disposable cup having a rim to a blender comprising:
a support base having a first face and a second face and an opening, the first face of the support base having a flat surface designed to support the rim of the disposable cup around the opening;
a clamp ring designed to press the rim of the disposable cup into pressing contact with the flat surface of the support base; and
a blade assembly connected to the second face of the support base, the blade assembly designed to be mated with a blender.

9. An apparatus as in claim 8, the support base further comprising a clamp collar circumscribing the flat surface.

10. An apparatus as in claim 9, the clamp ring designed to work in cooperation with the clamp collar to press the rim disposable cup into pressing contact with the flat surface of the support base.

11. An apparatus as in claim 8, wherein the lower surface of the clamp ring includes a hollow.

12. An apparatus as in claim 8, wherein the flat surface of the support base includes a seal ring.

13. An apparatus as in claim 8, wherein the opening of the support base comprises a cavity having a thickness of at least ¾ of an inch in which the blade of the blade assembly is design to rotate.

14. An apparatus as in claim 8, wherein the clamp ring includes an enclosure to enclose at least a portion of the bottom of the cup.

15. A blender comprising:
a motor having a drive socket;
a motor housing;
a support base having a first face and a second face and an opening, the first face of the support base having a flat surface designed to support the rim of the disposable cup around the opening;
a clamp ring designed to press the rim of the disposable cup into pressing contact with the flat surface of the support base; and
a mating collar connected to the second face of the support base, the mating collar designed to mate with a blade assembly separate from but attachable to the driver socket.

16. An apparatus as in claim 15, the support base further comprising a clamp collar circumscribing the flat surface.

17. An apparatus as in claim 16, the clamp ring designed to work in cooperation with the clamp collar to press the rim disposable cup into pressing contact with the flat surface of the support base.

18. An apparatus as in claim 15, wherein the lower surface of the clamp ring includes a hollow.

19. An apparatus as in claim 15, wherein the flat surface of the support base includes a seal ring.

20. An apparatus as in claim 15, wherein the opening of the support base comprises a cavity having a thickness of at least ¾ of an inch in which the blade of the blade assembly is design to rotate.

21. An apparatus as in claim 15, wherein the clamp ring includes an enclosure to enclose at least a portion of the bottom of the cup.

22. A blender comprising:
a motor having a drive socket;
a motor housing;
a support base having a first face and a second face and an opening, the first face of the support base having a flat surface designed to support the rim of the disposable cup around the opening;
a clamp ring designed to press the rim of the disposable cup into pressing contact with the flat surface of the support base; and
a blade assembly connected to the second face of the support base, the blade assembly attachable to the drive socked.

23. An apparatus as in claim 22, the support base further comprising a clamp collar circumscribing the flat surface.

24. An apparatus as in claim 23, the clamp ring designed to work in cooperation with the clamp collar to press the rim disposable cup into pressing contact with the flat surface of the support base.

25. An apparatus as in claim 22, wherein the lower surface of the clamp ring includes a hollow.

26. An apparatus as in claim 22, wherein the flat surface of the support base includes a seal ring.

27. An apparatus as in claim 22, wherein the opening of the support base comprises a cavity having a thickness of at least ¾ of an inch in which the blade of the blade assembly is design to rotate.

28. An apparatus as in claim 22, wherein the clamp ring includes an enclosure to enclose at least a portion of the bottom of the cup.
